(19) United States
(12) Patent Application Publication
(10) Pub. No.: US 2003/0025696 A1
(43) Pub. Date: Feb. 6, 2003

(54) Method and system for generating a graphical representation

(76) Inventor: Nicholas John Mulgan, Wellington (NZ)

Correspondence Address: David E. Bruhn, DORSEY & WHITNEY LLP, Suite 1500, 50 South Sixth Street, Minneapolis, MN, 55402-1498, US

(21) Appl. No.: 10/177,619

(22) Filed: Jun. 20, 2002

Related U.S. Application Data
(63) Continuation of application No. PCT/NZ00/00243, filed on Dec. 7, 2000.

(30) Foreign Application Priority Data
Dec. 22, 1999 (NZ) 502019

(51) Int. Cl. G06T 11/20

(52) U.S. Cl. 345/440

(57) ABSTRACT

The invention provides a method of generating a graphical representation of two or more finite sets of elements, the method comprising the steps of calculating the number of elements in each set, the number of elements in the union of all sets, and the number of elements in each set intersection; displaying a plurality of closed curves, the closed curves representing respective sets, the are bounded by each closed curve being proportional to the ratio of the number of elements in the corresponding set to the number of elements in the union of all sets; and aligning each closed curve relative to each other closed curve, the area bounded by the overlap of each curve being proportional to the ratio of the number of elements in the corresponding set intersection to the number of elements in the union of all sets.

### RELATED APPLICATIONS

This application is a continuation of PCT/NZ00/00243, filed on Dec. 7, 2000, which claims priority to New Zealand Patent No. 502019, filed on Dec. 22, 1999, both of which are herein incorporated by reference.

### FIELD OF INVENTION

The invention relates to a system and method of generating a graphical representation of two or more finite sets of elements. The invention is particularly suitable for generating a proportional Venn diagram.

### BACKGROUND TO INVENTION

The low cost of mass data storage enables organisations to generate and collect large volumes of data. It is often desirable for an organisation to be able to identify and highlight trends and other features of this data. Graphical representations of this data are very useful, particularly where the data is to be displayed to a non-technical audience.

Graphical representations of data include line graphs such as frequency and cumulative frequency graphs. Graphical representations also include bar graphs and pie charts which are particularly useful where the data is grouped into mutually exclusive sets. It is useful to display bar graphs and pie charts in a proportional form. For example, the height of a particular bar in a bar graph could be represented as being proportional to the proportion that bar represents of the entire group of data. Similarly, the area of a segment in a pie chart could represent the proportion that segment represents of the total data.

Where the data falls into non-exclusive sets, it is often useful to display each set together with the elements which are common to two or more sets, known as the intersections of those sets. An example of this type of graphical representation is a Venn diagram. It would be useful to generate a proportional Venn diagram in which the areas of the respective sets and the intersections of those sets in the representation is in the same proportion to the total area of the Venn diagram as the number of individual sets and set intersections to the number of elements in the set union.

Such a proportional Venn diagram would enable a person viewing the diagram to quickly and easily identify information contained in the diagram.

### SUMMARY OF INVENTION

In broad terms in one form the invention comprises a method of generating a graphical representation of two or more finite sets of elements, the method comprising the steps of calculating the number of elements in each set, the number of elements in the union of all sets, and the number of elements in each set intersection; displaying a plurality of closed curves, the closed curves representing respective sets, the area bounded by each closed curve being proportional to the ratio of the number of elements in the corresponding set to the number of elements in the union of all sets; and aligning each closed curve relative to each other closed curve, the area bounded by the overlap of each curve being proportional to the ratio of the number of elements in the corresponding set intersection to the number of elements in the union of all sets.

In another form the invention comprises a method of generating a graphical representation of three or more finite sets of elements, the method comprising the steps of calculating the number of elements in each set, the number of elements in the union of all sets, and the number of elements in each set intersection; displaying a polygon representing the intersection of all sets, the area bounded by the polygon representing the ratio of the number of elements in the intersection of all sets to the number of elements in the union of all sets; and displaying further polygons representing the respective intersections of successive set intersections, the area bounded by each polygon representing the ratio of the number of elements in the set intersection to the number of elements in the union of all sets.

In another form the invention comprises a system of generating a graphical representation of three or more finite sets of elements, the system comprising a calculating component arranged to calculate the number of elements in each set, the number of elements in the union of all sets, and the number of elements in each set intersection; a display arranged to display a polygon representing the intersection of all sets, the area bounded by the polygon representing the ratio of the number of elements in the intersection of all sets to the number of elements in the union of all sets; the display further arranged to display further polygons representing the respective intersections of successive set intersections, the area bounded by each polygon representing the ratio of the number of elements in the set intersection to the number of elements in the union of all sets.

In broad terms in another form the invention comprises a system of generating a graphical representation of two or more finite sets of elements comprising the means for calculating the number of elements in each set; means for calculating the union of all sets; means for calculating the intersection(s) of respective pairs of sets; and display means arranged to display a graphical representation of the sets wherein the size of the representations of each set and set intersection is substantially the same proportion to the size of the entire graphical representation as the number of elements in each set and set intersection to the number of elements in the set union.

### BRIEF DESCRIPTION OF THE FIGURES

Preferred forms of the method and system of generating a graphical representation will now be described with reference to the accompanying Figures in which:

FIG. 1 is a block diagram of the system of the invention;

FIG. 2 is a flow chart indicating operation of the invention;

FIG. 3 illustrates the generation of a Venn diagram;

FIGS. 4 to 6 illustrate examples of Venn diagrams generated by the invention;

FIG. 7 illustrates generation of another form of Venn diagram;

FIG. 8 illustrates another form of Venn diagram;

FIGS. 8A, 8B and 8C show different sets represented by the Venn diagram of FIG. 8;

FIGS. 9 and 10 illustrate the generation of the Venn diagram of FIG. 8;

FIG. 11 illustrates generation of another Venn diagram; and

FIGS. 12 to 14 illustrate the generation of another Venn diagram.

### DETAILED DESCRIPTION OF PREFERRED FORMS

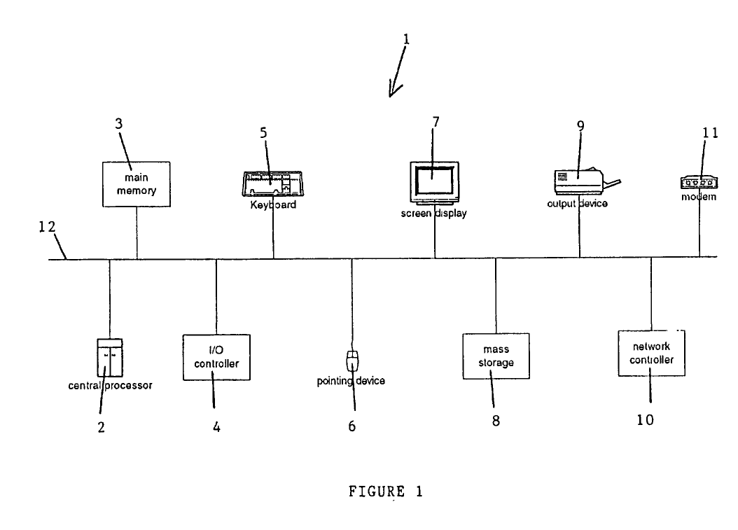

Referring to FIG. 1, the invention is preferably installed on a system 1 which typically comprises a central processor 2, a main memory 3 for example RAM and an input/output controller 4. The computer system 1 also comprises peripherals such as a keyboard 5, a pointing device 6 for example a mouse, track ball or touch pad, a display or screen device 7, a mass storage memory 8, for example a hard disk, floppy disk or optical disc, and an output device 9 for example a printer. The system 1 could also include a network interface card or controller 10 and/or a modem 11. The system 1 could further include wireless data transmission apparatus. The individual components of the system 1 could communicate through a system bus 12. Alternatively, the various component of the system 1 could be connected via a suitable network or networks, for example a local area network or LAN, a wide area network or WAN, an Internet, Intranet, wireless access network, telecommunication network, or any combination of the foregoing.

The system 1 is arranged to generate images and other graphical representations which are stored in random access memory 3 or storage devices 8. The system is arranged to display these images on display device 7 and to produce hard copies of these images on output device 9. The preferred system 1 includes a display buffer which may be implemented in either software or hardware. The invention is directed to a method and system for generating a graphical representation which may then be displayed on the display device 7, stored in storage device 8, or sent to output device 9 to produce a hard copy of the graphical representation. It is envisaged that the invention could be implemented as software or hardware.

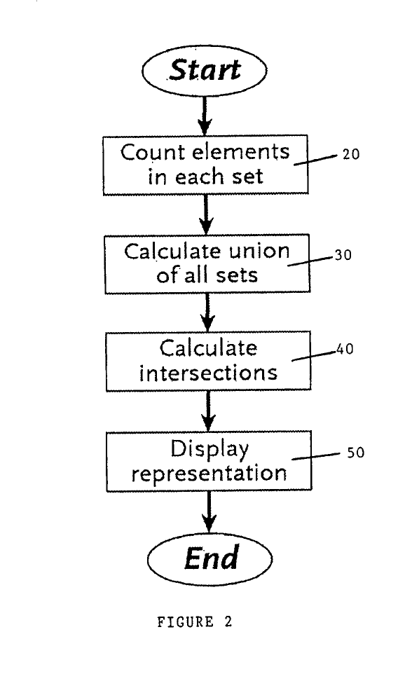

FIG. 2 illustrates the main features of the method and system of the invention. The invention is described, by way of example, with reference to persons visiting a casino. As shown at 20, the elements of each set are first counted. One set could be, for example, the set of people who visit a particular casino on Friday. The second set could be, for example, the set of people who visit the same casino on Saturday. This data could be obtained by identifying the consumers who have purchased tokens from the casino for use on that particular day. Each set could be constructed by a suitable database query and the resulting sets counted or could be manually counted. As shown at step 30, the union of each set is identified. Once again, a suitable database query could be constructed to identify the set of individuals who visited the casino on either Friday or Saturday. This set is the union of the set of people who visited the casino on Friday and the set of people who visited the casino on Saturday. The number of individuals in this set union is counted.

As shown at step 40, the set intersections are calculated. Using a suitable database query, the set of those people who visited the casino on both Friday and Saturday is then identified and counted. This set is the intersection of the set of individuals who visited the casino on Friday and the set of individuals who visited the casino on Saturday.

As shown at 50, a graphical representation of the above data is then produced. As will be described below, the preferred graphical representation is a proportional Venn diagram, in which the number in each set and set intersection and the proportion of these numbers to the number in the set union is shown graphically.

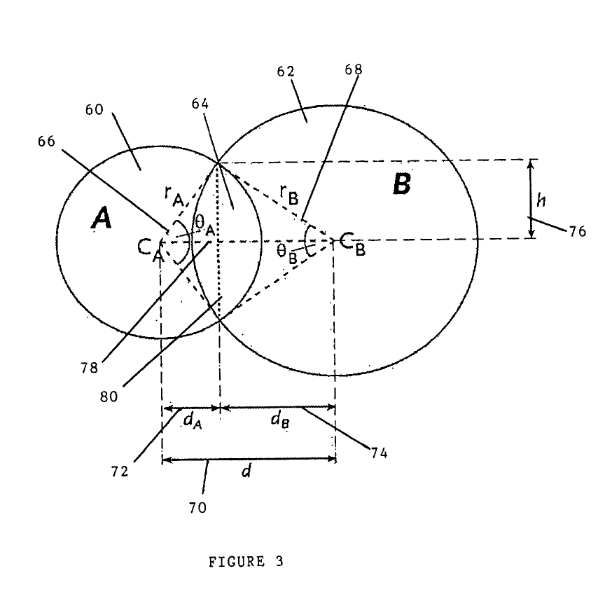

FIG. 3 illustrates the preferred method of calculating the size of individual items in the Venn diagram to produce a graphical representation which can then be displayed on a display device or printed in hard copy in the known way.

As shown in FIG. 3, there is a set A indicated at 60 and a set B indicated at 62. Set A may represent, for example, the set of individuals who visited a casino on Friday and set B may represent the set of individuals who visited the casino on Saturday. Set A has one or more elements, known as finite cardinality of n(A) and set B has finite cardinality of n(B). The intersection of A and B, or A∩B is indicated at 64 and has cardinality of n(A∩B). Circle A has radius r_{A} indicated at 66 and Circle B has radius r_{B} indicated at 68. The centre of A shown as C_{A} and the centre of B shown as C_{B} are spaced a certain distance from each other, this distance shown as d at 70.

In order to generate a proportional Venn diagram correctly, it is necessary to determine the correct radii r_{A} and r_{B} of each circle which will determine the size of each circle and to determine correctly the distance d between the centres of the circles which, together with the sizes of the radii, will determine the correct intersection size 64 of the circles.

To produce proportional graphical representations of sets A and B, the ratio of area A to area B should be the same as the number of elements in set A to the number of elements in set B, represented as follows:

area(A):area(B)=n(A):n(B)

Assuming r_{A}=1, r_{B} is calculated as follows:

$${r}_{B} = \sqrt{\frac{n ( B )}{n ( A )}}$$

It is assumed that n(A∩B)≦n(A) and n(A∩B)≦n(B). This means that the number of people who visit the casino on both Friday and Saturday is less than or equal to the number of people who visit the casino on Friday and less than or equal to the number of people who visit the casino on Saturday.

If every individual who visits the casino on Friday also visits the casino on Saturday, the Venn diagram for this situation is simply drawn with one circle representing the Friday group inside the other circle representing the Saturday group. This is represented as n(A∩B)=n(A) meaning that A is a subset of B, or A⊂B. Likewise, if every individual who visits the casino on Saturday also visits the casino on Friday, then n(A∩B)=n(B) and B⊂A. This diagram may be drawn by representing a circle for the Saturday group inside a circle for the Friday group.

If every individual visits the casino on both Friday and Saturday, the resulting Venn diagram would be simply two coincident circles.

The invention is directed to the situation where n(A∩B)<n(A), n(B) and it is necessary to find the appropriate value for d to ensure that intersection area 64 is represented correctly.

The area of A∩B is given by the following equation:

$$Area ( A ⋂ B ) = \frac{{r}_{A}^{2} ( {θ}_{A} - sin {θ}_{A} ) + {r}_{B}^{2} ( {θ}_{B} - sin {θ}_{B} )}{2} \qquad ( 1 )$$

To find the relationship between this area and d, three new distances are defined, namely d_{A} indicated at 72, d_{B} indicated at 74, and h indicated at 76. d_{A} is the distance from C_{A} to the intersection of line 78 between C_{A} and C_{B} and line 80 between the two intersections of circles A and B. This line 80 has length of 2 h. d_{B} is the distance from C_{B} to the intersection of line 78 with line 80.

This may be represented as follows:

d=d_{A}+d_{B}

r_{A}²=d_{A}²+h²

r_{B}²=d_{B}²+h²

These equations solve to give the following:

$$\begin{matrix}{d}_{A} -> \frac{{d}^{2} + {r}_{A}^{2} - {r}_{B}^{2}}{2 d} & ( 2 ) \\ {d}_{B} -> \frac{{d}^{2} - {r}_{A}^{2} + {r}_{B}^{2}}{2 d} & ( 3 ) \\ h -> \frac{\sqrt{- {d}^{4} + 2 {d}^{2} {r}_{A}^{2} - {r}_{A}^{4} + 2 {d}^{2} {r}_{B}^{2} + 2 {r}_{A}^{2} {r}_{B}^{2} - {r}_{B}^{4}}}{2 d} & ( 4 )\end{matrix}$$

Substituting equations (2), (3) and (4) into equation (1) together with the following equations

θ_{A}=2 cos⁻¹(d_{A}/r_{A}) (5)

sin θ_{A}=2d_{A}h/r_{A}² (6)

θ_{B}=2 cos⁻¹(d_{B}/r_{B}) (7)

sin θ_{B}=2d_{B}_{h/r}_{B}² (8)

and equating the above equations to:

area(A∩B):area(A)=n(A∩B):n(A)

gives an equation for

$$\frac{n ( A ⋂ B )}{n ( A )}$$

in terms of d alone as follows:

$$\frac{n ( A ⋂ B )}{n ( A )} = \frac{1}{Π} ( {cos}^{- 1} ( {d}_{A} / {r}_{A} ) - {hd}_{A}^{2} / {r}_{A}^{2} + \frac{{r}_{B}^{2} ( {cos}^{- 1} ( {d}_{B} / {r}_{B} ) - {hd}_{B} / {r}_{B}^{2} )}{{r}_{A}^{2}} ) \qquad ( 9 )$$

with d_{A}, d_{B} and h given by equations (2), (3) and (4) respectively.

Equation (9) cannot be inverted explicitly, but can be solved to find d for given

$$\frac{n ( A ⋂ B )}{n ( A )}$$

by a standard bracketing root finding method, for example, as described in Press et al “Numerical Recipes in C”, Second Edition, Cambridge University Press 1992, page 347, on initial interval [dₘᵢₙ, dₘₐₓ]=[|r_{A}−r_{B}|, r_{A}+r_{B}].

Once the correct radii r_{A} and r_{B} have been determined, together with the correct value for d, a graphical representation is then generated based on these values and displayed on display device 7 or output to output device 9. By spacing the centre of the circles A and B a certain distance d from each other, the correct area of intersection can be displayed. The advantage provided by the invention is that the resulting graphical representations, for example Venn diagrams, are proportional.

The following table provides sample data for which graphical representations are generated.

| EX- | | | | |
|---|---|---|---|---|
| AMPLE | | | FRIDAY ∩ | FRIDAY ∪ |
| NUMBER | FRIDAY | SATURDAY | SATURDAY | SATURDAY |
| 1 | 70 | 95 | 12 | 153 |
| 2 | 60 | 40 | 35 | 65 |
| 3 | 100 | 10 | 10 | 100 |

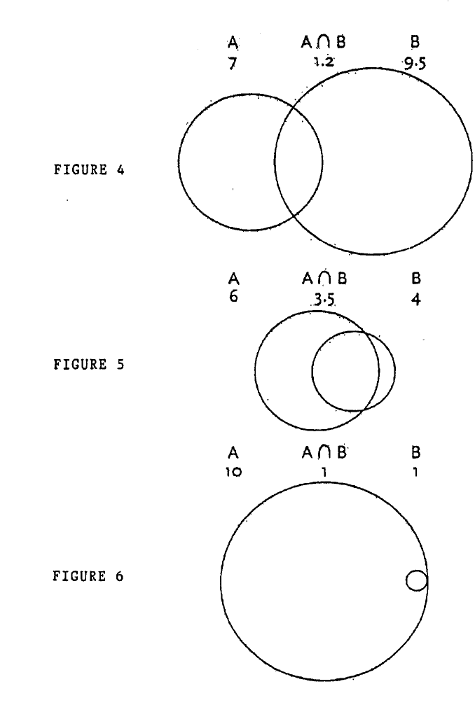

In example 1 above, 70 people visit the casino on Friday and 95 people visit the casino on Saturday. Twelve people visit the casino both on Friday and Saturday. The total number of people visiting the casino on either Friday or Saturday is 153. Appropriate values for the radius of each circle and the distance between the centres of the circles are calculated. The resulting Venn diagram is shown in FIG. 4.

In Example 2, 60 people visit the casino on Friday and 40 people visit the casino on Saturday. Thirty five of these people visit the casino both on Friday and on Saturday, and 65 people visit the casino either on Friday or on Saturday. FIG. 5 shows the resulting Venn diagram generated by the invention.

Example 3 is shown in which 100 people visit the casino on Friday and 10 people visit the casino on Saturday. Each individual who visited the casino on Saturday also visited the casino on Friday. The total number of people who visited the casino either on Friday or on Saturday is 100. The resulting Venn diagram generated by the invention is shown in FIG. 6.

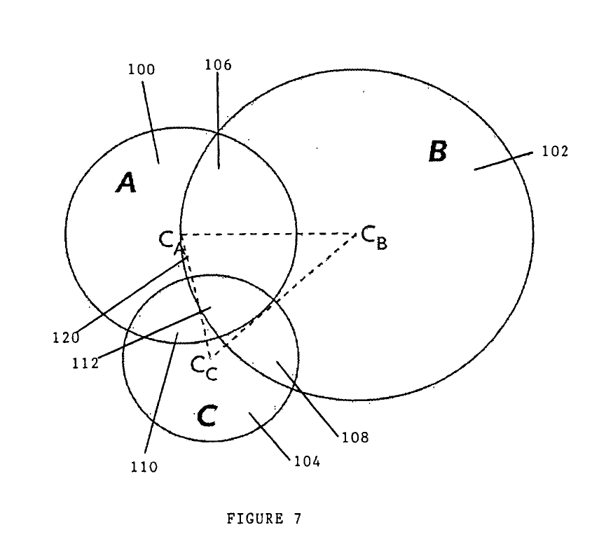

In some circumstances, it is envisaged that the invention could be used to generate Venn diagrams involving three or more sets of data. FIG. 7 shows a typical Venn diagram involving three sets of data. Set A indicated at 100, Set B indicated at 102, and Set C indicated at 104 are represented by three pair-wise intersecting circles having centres C_{A}, C_{B} and C_{C} respectively. In the Venn diagram of FIG. 7, centres C_{A}, C_{B} and C_{C} are positioned at the vertices of a triangle indicated at 120.

A∩B is indicated at 106, B∩C is indicated at 108 and A∩C is indicated at 110. A∩B∩C is indicated at 112.

By adjusting the radii of the circles and by adjusting the lengths of the sides of triangle 120, a Venn diagram can be generated for some sets of data. The lengths of the sides of triangle 120 are Preferably calculated using the same method described above for Venn diagrams involving two sets. For example, the length of the line between C_{A} and C_{B}, the length of the line between C_{B} and C_{C}, and the length of the line between C_{A} and C_{C} are each calculated in the same way as line d of FIG. 3.

In some circumstances, it is difficult, if not impossible, to generate proportional Venn diagrams involving three or more sets of data using circles to represent the sets. For example, when there are no elements in the intersections between any two sets, it is no longer possible to form a triangle connecting the centres of each set. In graph theory terms, this results in a disconnected graph.

By generating Venn diagrams using polygons, for example, triangles and quadrilaterals, as an alternative to circles, it is possible to generate proportional Venn diagrams involving three or more sets of data.

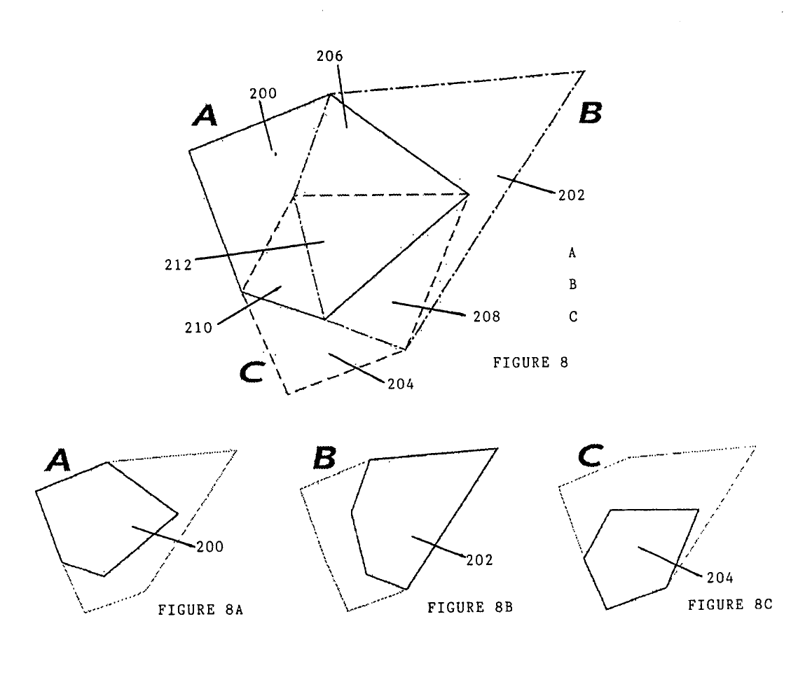

FIG. 8 shows the Venn diagram of FIG. 7 represented using polygons instead of circles to represent sets and set intersections. Set A is indicated at 200 in FIG. 8 and FIG. 8A, Set B is indicated at 202 in FIGS. 8 and 8B and Set C is indicated at 204 in FIGS. 8 and 8C.

A∩B is indicated at 206, B∩C is indicated at 208, and A∩C is indicated at 210. A∩B∩C is indicated at 212.

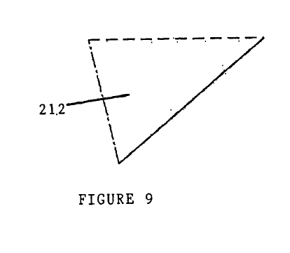

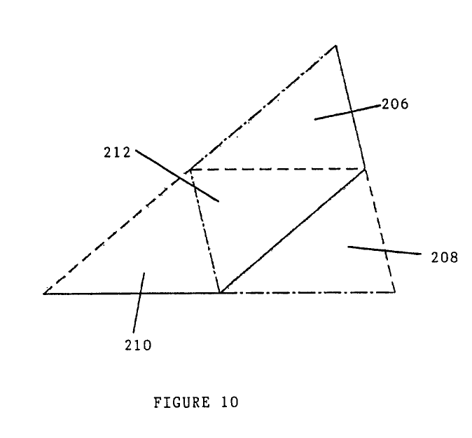

Generation of this Venn diagram of FIG. 8 will now be described with reference to FIGS. 9 and 10. As shown in FIG. 9, an equilateral triangle is generated as shown at 212 to represent A∩B∩C. In some cases, A∩B∩C will have a cardinality of 0, and this situation is described below.

As shown in FIG. 10, an isosceles triangle is generated as shown at 206 to represent A∩B∩C′, as all of the elements common to both Sets A and B, but not C. It will be appreciated that the isosceles triangle has sufficient height to show the correct proportion of the set intersection to the set union. Isosceles triangles 208 and 210 are also generated to represent the set intersections A′∩B∩C and A∩B′∩C respectively. In some circumstances, these set intersections will have a cardinality of 0 and these situations are described below.

The next step is to complete the process of generating the diagram of FIG. 8. A triangle is generated as shown at 200 to represent A∩B′∩C′. Triangles 202 and 204 are also generated to represent A′∩B∩C′ and A′∩B′∩C respectively.

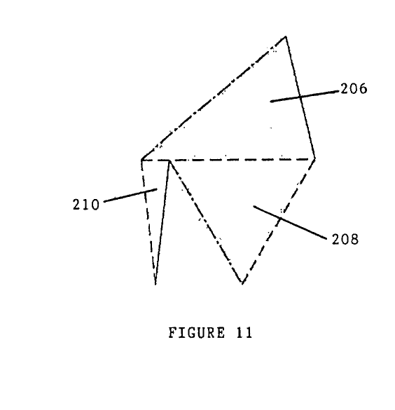

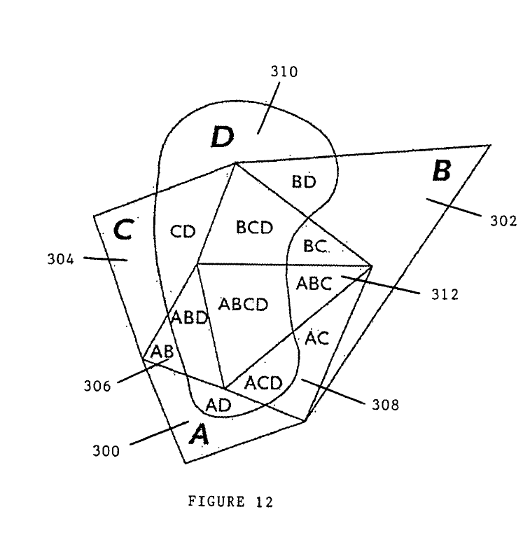

It is possible that one or more of the seven sets and set intersections as shown at 200, 202, 204, 206, 208, 210 and 212 may have a cardinality of 0. For example, A∩B∩C could have a cardinality of 0. As shown in FIG. 11, the area represented by A∩B∩C where this set has a cardinality of 0 is formed by collapsing the area 212 as shown in FIGS. 9 and 10 and repositioning triangles 210 and 208.

Any set or set intersection with a cardinality of 0 can be represented by collapsing the appropriate shape representing the set or set intersection with a cardinality of 0.

Using polygons instead of circles to represent sets and set intersections, the invention could be used to generate Venn diagrams involving two or more sets of data, and in some cases, four or more sets of data, as will be described with reference to FIGS. 12 to 14.

Referring to FIG. 12, a proportional Venn diagram involving three sets is generated. Set A (or more specifically A∩B′∩C′) is indicated at 300, Set B is indicated at 302, and Set C is indicated at 304. A∩B is indicated at 306, B∩C is indicated at 308, and A∩C is indicated at 310. A∩B∩C is indicated at 312.

Adapting Venn's construction as disclosed in J. Venn On the diagrammatic and mechanical representation of propositions and reasoning, the London, Edinburgh, and Dublin Psychological Magazine and Journal of Science 9 (1880) specifies that a curve 314 is drawn which represents the boundary of new Set D and passes through each of the intersection regions of the existing sets. As shown in FIG. 12, each of regions 300, 302, 304, 306, 308, 310 and 312 are divided into two separate regions by curve 314.

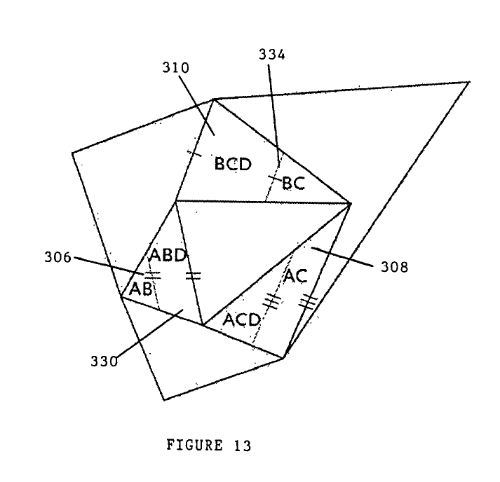

Referring to FIG. 13, the curve 314 from FIG. 12 is represented by a series of line segments. Preferably line segments 330, 332 and 334 are positioned as shown so that the line segments divide the set intersections into the correct proportions and so that the line segments are parallel to at least one of the boundaries of the set intersection. Positioning of the line segments in this way results in a diagram which is symmetric and aesthetically pleasing and assists a user in interpreting the data displayed in the diagram.

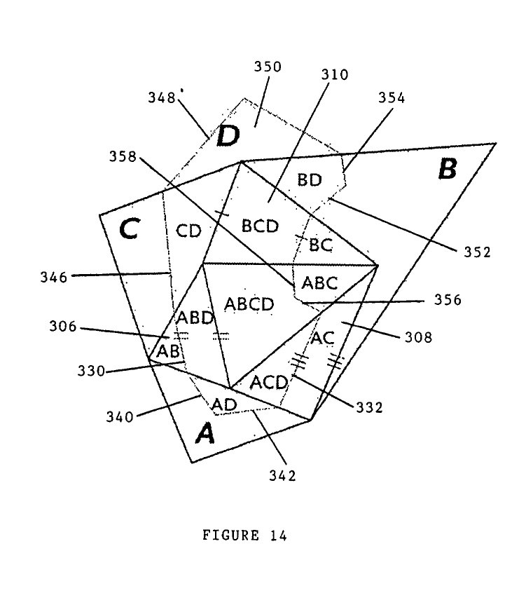

Referring to FIG. 14, line segments 330 and 332 are connected by line segments 340 and 342. Line segments 332 and 334 are connected by line segments 346, 348, 350, 352 and 354. Line segments 334 and 330 are connected by line segments 356 and 358. Preferably, the length, orientation and positioning of each line segment is selected to ensure that the sets and set intersections are divided in the correct proportions. Preferably the smallest number of line segments are used.

It is envisaged that the invention could be used to generate Venn diagrams involving five or more sets of data, using the same methods described above.

In summary, the preferred system and method enables the generation of proportional Venn diagrams with sets represented by circles, by calculating the correct radius of each circle representing a set and by calculating the correct distance between the centres of intersecting circles.

The preferred system and method also enables the generation of proportional Venn diagrams with sets represented by polygons rather than circles, for example, triangles and quadrilaterals. It is also envisaged that Venn diagrams may be generated in which sets are presented as a combination of circles and polygons.

Generation and display of the proportional Venn diagrams enables a person viewing the diagram to quickly and easily identify information contained in the diagram.

It is also envisaged that the invention may be applied to the generation of 3-dimensional Venn diagrams of which perspective views are then displayed.

The foregoing describes the invention including preferred forms thereof. Alterations and modifications as will be obvious to those skilled in the art are intended to be incorporated within the scope hereof.

1. A method of generating a graphical representation of two or more finite sets of elements, the method comprising the steps of:
calculating the number of elements in each set, the number of elements in the union of all sets, and the number of elements in each set intersection;
displaying a plurality of closed curves, the closed curves representing respective sets, the area bounded by each closed curve being proportional to the ratio of the number of elements in the corresponding set to the number of elements in the union of all sets; and
aligning each closed curve relative to each other closed curve, the area bounded by the overlap of each curve being proportional to the ratio of the number of elements in the corresponding set intersection to the number of elements in the union of all sets.

2. A method of generating a graphical representation of two finite sets of elements as claimed in claim 1 further comprising the steps of:
calculating the radius r_{A} of a circle A, the area bounded by circle A being proportional to the ratio of the number of elements in the first finite set to the number of elements in the union of both sets;
calculating the radius r_{B} of a circle B, the area bounded by circle B being proportional to the ratio of the number of elements in the set B to the number of elements in the union of both sets; and
spacing the centre of circle A from the centre of circle B a calculated distance from other, the area of overlap of the circles being proportional to the ratio of the number of elements in the set intersection to the number of elements in the union of both sets.

3. A method of generating a graphical representation of three finite sets of elements as claimed in claim 1, the method further comprising the steps of:
calculating the radius r_{A} of a circle A, the area bounded by circle A being proportional to the ratio of the number of elements in the first finite set to the number of elements in the union of all sets;
calculating the radius r_{B} of a circle B, the area bounded by circle B being proportional to the ratio of the number of elements in the second finite set to the number of elements in the union of all sets;
calculating the radius r_{C} of a circle C, the area bounded by circle C being proportional to the ratio of the number of elements in the third set to the number of elements in the union of all sets; and
spacing the centres of circles A, circle B and circle C respective calculated distances from each other, the area of overlap of each pair of circles being proportional to the ratio of the number of elements in the corresponding set intersection to the number of elements in the union of all sets.

4. A method of generating a graphical representation of three or more finite sets of elements, the method comprising the steps of:
calculating the number of elements in each set, the number of elements in the union of all sets, and the number of elements in each set intersection;
displaying a polygon representing the intersection of all sets, the area bounded by the polygon representing the ratio of the number of elements in the intersection of all sets to the number of elements in the union of all sets; and
displaying further polygons representing the respective intersections of successive set intersections, the area bounded by each polygon representing the ratio of the number of elements in the set intersection to the number of elements in the union of all sets.

5. A system of generating a graphical representation of two or more finite sets of elements, the system comprising:
a calculating component arranged to calculate the number of elements in each set, the number of elements in the union of all sets, and the number of elements in each set intersection;
a display arranged to display a plurality of closed curves, the closed curves representing respective sets, the area bounded by each closed curve being proportional to the ratio of a number of elements in the corresponding set to the number of elements in the union of all sets; and
an alignment component arranged to align each closed curve relative to each other closed curve, the area bounded by the overlap of each curve being proportional to the ratio of the number of elements in the corresponding set intersection to the number of elements in the union of all sets.

6. A system of generating a graphical representation of two finite sets of elements as claimed in claim 5 wherein the display is arranged to calculate the radius r_{A} of circle A, the area bounded by circle A being proportional to the ratio of the number of elements in the first finite set to the number of elements in the union of both sets;
the display is arranged to calculate the radius r_{B} of a circle B, the area bounded by circle B being proportional to the ratio of the number of elements in the second set to the number of elements in the union of both sets; and
the alignment component is arranged to space the centre of circle A from the centre of circle B at a calculated distance from each other, the area of overlap of the circles being proportional to the ratio of the number of elements in the corresponding set intersection to the number of elements in the union of all sets.

7. A system of generating a graphical representation of three finite sets of elements as claimed in claim 5 wherein:
the display is arranged to calculate the radius r_{A} of a circle A, the area bounded by circle A being proportional to the ratio of the number of elements in the first set from the number of elements in the union of both sets:
the display is arranged to calculate the radius r_{B} of the circle B, the area bounded by circle B being proportional to the ratio of the number of elements in the second set to the number of elements in the union of both sets;
the display is arranged to calculate the radius r_{C} of a circle C, the area bounded by circle C being proportional to the ratio of the number of elements in the third set to the number of elements in the union of all sets; and
the alignment component is arranged to space the centres of circle A, circle B and circle C at respective calculated distances from each other, the area of overlap of each pair of circles being proportional to the ratio of the number of elements in the corresponding set intersection to the number of elements in the union of all sets.

8. A system of generating a graphical representation of three or more finite sets of elements, the system comprising:
a calculating component arranged to calculate the number of elements in each set, the number of elements in the union of all sets, and the number of elements in each set intersection;
a display arranged to display a polygon representing the intersection of all sets, the area bounded by the polygon representing the ratio of the number of elements in the intersection of all sets to the number of elements in the union of all sets;
the display further arranged to display further polygons representing the respective intersections of successive set intersections, the area bounded by each polygon representing the ratio of the number of elements in the set intersection to the number of elements in the union of all sets.
